(19) United States
(12) Patent Application Publication
(10) Pub. No.: US 2014/0203780 A1
(43) Pub. Date: Jul. 24, 2014

(54) SYSTEM AND METHOD FOR ACTIVE CHARGE AND DISCHARGE CURRENT BALANCING IN MULTIPLE PARALLEL-CONNECTED BATTERY PACKS

(71) Applicant: TEXAS INSTRUMENTS INCORPORATED, Dallas, TX (US)

(72) Inventors: Yongxuan Hu, Cupertino, CA (US); Christopher Lee Betty, Arlington, TX (US); J. Randall Cooper, Lucas, TX (US)

(73) Assignee: TEXAS INSTRUMENTS INCORPORATED, Dallas, TX (US)

(21) Appl. No.: 13/748,792

(22) Filed: Jan. 24, 2013

(51) Int. Cl. H02J 7/00

(52) U.S. Cl. CPC H02J 7/0014
USPC 320/112; 320/126

(57) ABSTRACT

Methods and systems are presented for charging and/or discharging multiple parallel-connected battery packs in portable electronic devices, in which a charging or discharging current of a second battery pack is regulated based at least in part on a charging or discharging current of a first battery pack.

### FIELD OF THE INVENTION

The present disclosure relates to battery powered electrical circuits, and more particularly to systems and methods for balancing charge and discharge current in parallel-connected battery packs.

### BACKGROUND OF THE INVENTION

Battery packs are used for a variety of consumer, automotive, medical, and industrial products, including notebook computers, tablets, digital cameras, mobile phones, etc. As the popularity and functionality of these devices increases, increased battery capacity and reduced charging time is desirable to allow users to operate portable devices for extended periods of time without having to frequently recharge the battery packs. Accordingly, devices are being designed to accommodate multiple parallel-connected battery packs. However, pack to pack variations may lead to differences in charge and discharge current when multiple battery packs are being charged and discharged in parallel. This charging/discharging current flow difference in certain cases can be as high as +/−10%, and may lead to increased total charge time limited by the slowest charging pack, as well as shorter battery pack lifetime due to the uneven charging and discharging. Thus, a need remains for improved apparatus and techniques for charging and/or discharging parallel-connected battery packs.

### SUMMARY OF THE INVENTION

Various aspects of the present disclosure are now summarized for compliance with 37 CFR §1.73 to facilitate a basic understanding of the disclosure by briefly indicating the nature and substance of the disclosure, where this summary is not an extensive overview of the disclosure, and is intended neither to identify certain elements of the disclosure, nor to delineate the scope thereof. Rather, the primary purpose of this summary is to present some concepts of the disclosure in a simplified form prior to the more detailed description that is presented hereinafter, and this summary is submitted with the understanding that it will not be used to interpret or limit the scope or meaning of the claims.

Battery pack charge/discharge systems are provided for charging or discharging two or more parallel-connected battery packs, and portable electronic devices are disclosed which include such a battery pack charge/discharge system. The charge/discharge system includes first and second transistors connected in corresponding charging circuits in series with respective first and second battery packs, where the charging circuits are connected in parallel between a system power node and a system ground node. The system also includes a regulator which provides a control signal to the second transistor to regulate charging or discharging current of the second battery pack based at least partially on the first charging or discharging current of the first battery pack.

The regulator in certain embodiments attempts to equalize the charging or discharging currents, or may control the relative charging or discharging currents of two battery packs based on the ratio of the battery pack capacities. In certain embodiments, moreover, the system may regulate charging or discharging of one pack according to the charging/discharging of another pack when the battery pack voltages exceed a predetermined threshold. The control transistor in certain embodiments is a field effect transistor (FET) and the regulator circuit provides the charging control signal to operate the transistor in an ohmic mode (triode range or mode) to vary the series impedance between the system power node and the battery pack during charging or discharging. In certain embodiments, moreover, the regulator circuit provides control signals to both charging transistors, and regulates the first charging or discharging current at least partially according to the second charging or discharging current. The regulator may include one or more operational transconductance amplifiers (OTAs) receiving inputs indicative of the charging or discharging currents and providing one or more outputs to generate the control signal(s) for operating the charging/discharging transistor(s).

Methods are presented for charging or discharging multiple parallel-connected battery packs, including controlling flow of a first charging or discharging current to or from a first battery pack, as well as regulating the flow of a second charging or discharging current to or from a second battery pack at least partially according to the first charging or discharging current. In certain embodiments, the method involves substantially equalizing the first and second charging or discharging currents. Other embodiments involve regulating the ratio of the first and second charging or discharging currents at least partially according to the ratio of the first and second battery pack capacities. Certain embodiments of the method, moreover, involve separately or independently charging the battery packs when one or both pack voltages are low, and regulating the second charging or discharging current at least partially according to the first charging or discharging current when the voltages of the first and second battery packs exceed a predetermined threshold.

### DESCRIPTION OF THE VIEWS OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings, in which:

FIG. 1 is a simplified schematic diagram illustrating a portable electronic device connected to an external power supply for driving a system load and charging parallel-connected battery packs using a battery pack charge/discharge system that regulates the charge/discharge current flowing in one battery pack according to the charge/discharge current of another parallel-connected battery pack;

FIG. 2 is a schematic diagram illustrating the portable electronic device of FIG. 1 without the external power supply, with the battery packs discharging to drive the system load;

FIG. 3 is a schematic diagram illustrating a battery pack charge/discharge system with a regulator controlling charging or discharging of more than two battery packs;

FIG. 4 is a schematic diagram illustrating further details of an exemplary charge/discharge system using an operational transconductance amplifier for charging two parallel-connected battery packs; and

FIG. 5 is a schematic diagram illustrating a charge/discharge system using two or more operational transconductance amplifiers for charging three or more parallel-connected battery packs.

### DETAILED DESCRIPTION

One or more embodiments or implementations are hereinafter described in conjunction with the drawings, wherein like reference numerals are used to refer to like elements throughout, and wherein the various features are not necessarily drawn to scale.

The present disclosure provides apparatus and methods for charging or discharging multiple battery packs connected in parallel, and may be advantageously employed to reduce charging times as well as increase battery runtime and battery pack lifetimes, particularly in systems using batteries with high pack-to-pack variations and/or where two or more parallel-connected batteries have different capacities and/or are of different ages. For example, notebook computers may be powered from a main battery pack as well as from one or more ancillary battery packs (e.g., a second battery provided in lieu of an optical drive), where the main battery pack and the secondary battery pack are of different capacities, and the main battery pack may be used alone at times, and is thus farther along in terms of product lifetime than the secondary battery pack. In such situations, multiple battery packs are effectively coupled in parallel when installed in the device, and simply charging or discharging all the packs at the same charge or discharge current levels may lead to the above-mentioned problems.

Accordingly, techniques and apparatus are disclosed herein for charging or discharging multiple parallel-connected batteries in which the charging or discharging current flow in one battery pack is regulated according to the charging or discharging current flow in another battery pack. This approach can be scaled to accommodate any number of parallel-connected battery packs, in which charging of one battery pack is done at least in part according to charging of another (e.g., reference) battery pack.

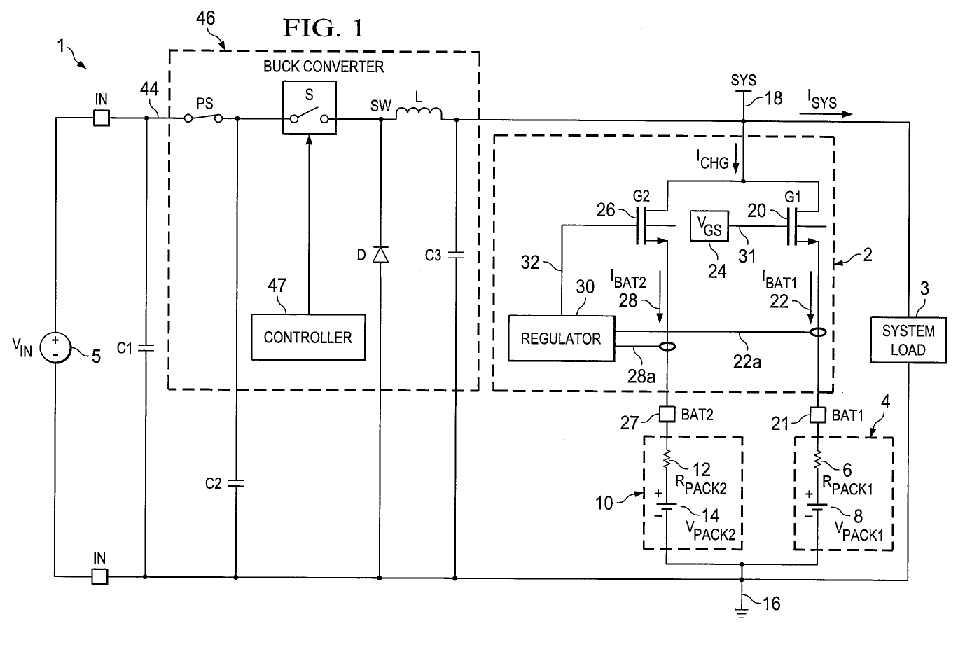

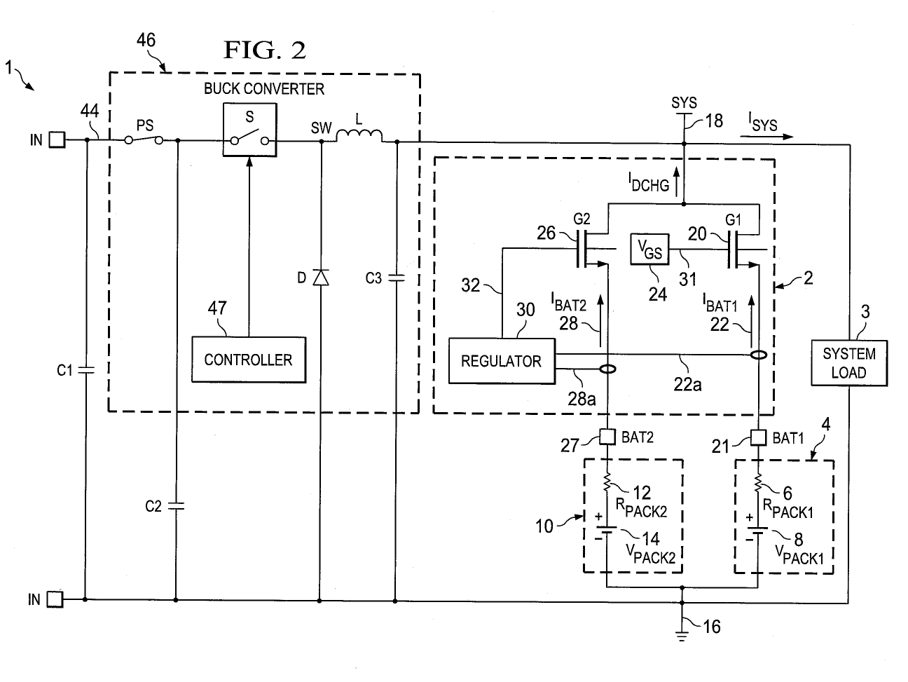

FIGS. 1 and 2 illustrate a portable electronic device 1, which can be a notebook or laptop computer, a tablet, a digital camera, a mobile phone, or other form or type of product having electronic circuitry powered by rechargeable battery packs. The device 1 includes first and second battery packs 4 and 10, which are coupled in parallel between a system power node 18 (SYS) and a system ground node 16. Although the device 1 is shown in FIGS. 1 and 2 as including two battery packs 4 and 10, the present disclosure contemplates devices having any integer number N parallel-connected battery packs, where N≧2. As shown in FIGS. 1 and 2, moreover, the battery packs 4 and 10 include battery cells 8 and 14 with associated pack voltages V_{PACK1} and V_{PACK2}, as well as series pack resistances 6 and 12 (R_{PACK1} and R_{PACK2}), respectively. The packs 8 and 14 may be single cells, or may include multiple battery cell components connected with one another in series, parallel or series-parallel configurations, where such cells provide the series resistances shown schematically in the drawings.

In operation, the battery packs 4 and 10 selectively provide electrical power (discharging operation) to a system load 3, such as electronic circuitry and electrical components of the device 1 (e.g., processor and memory circuits, display screens, etc., not shown), or the battery packs 4 and 10 may be charged using power from an external source 5 (charging operation). The device 1 has a power input with a positive (+) terminal 44 connected in FIG. 1 to receive DC input power from a power source 5, such as a notebook computer or mobile phone power adapter in one example. The DC input power is converted by a DC-DC buck converter 46 to provide power to the system power node 18 for providing load current I_{SYS} to the system load 3 and/or for providing charging current I_{CHG} to charge the battery packs 4 and 10 via a battery pack charge/discharge system 2. As seen in FIG. 2, the device 1 is also operable without connection to an external power source, in which case the system load 3 is powered by the battery packs 4 and 10 which provide discharge current I_{DCHG} to the system power node 18 via the charge/discharge system 2.

In the example of FIGS. 1 and 2, a filter capacitor C1 is connected across the power input terminals, and the upper (e.g., positive) DC input circuit branch 44 is connected via a reverse blocking power switch PS (e.g. FET) to a first internal node of the buck converter 46 at which the switch PS is connected to a high side power converter switch S, with a midpoint capacitor C2 connected between the first internal node in the system ground 16. A controller 47 operates the switch S to selectively connect the first internal node with a converter switch node SW. A fly back diode D has an anode connected to the system ground 16, as well as a cathode connected to the switch node SW, and an inductor L is connected between the switch node SW and the system power node 18 to form a buck converter. Although the illustrated example uses a buck converter 46, the concepts of the present disclosure can be used with any type of regulator and are not limited to buck converters. Other forms of DC-DC converters 46 may therefore be used in other embodiments. An output capacitor C3 is also connected across the converter output between the system power node 18 and the system ground node 16. In operation, the converter 46 selectively converts the input electrical power from the power source 5 in order to provide power to the system power node 18 for powering the system load 3 and/or for charging the battery packs 4 and 10.

The battery pack charge/discharge system 2 is a multi-mode circuit for selectively charging or discharging the battery packs 4 and 10, and includes first and second transistors 20 and 26, respectively, as well as a regulator 30. The first transistor 20 is connected in series with the first battery pack 4 in a first charging circuit, and operates according to a first control signal 31 to control a first charging or discharging current flow 22 (I_{BAT1}) between the SYS node 18 and the first battery pack 4. The second transistor 26 is connected in a second charging circuit, in series with the second battery pack 10. The second transistor 26 operates according to a second control signal 32 to control a second charging or discharging current 28 (I_{BAT2}) flowing between the SYS node 18 and the second battery pack 10. As seen in FIG. 1, the first and second charging circuits are connected in parallel between the system power node 18 and the ground node 16, and the battery packs 4 and 10 are thus connected in parallel.

The regulator circuit 30 can be any suitable circuitry which provides the second control signal 32 to the second transistor 26, and may also provide the gate control signal 31 to the first transistor 20 in certain embodiments. In particular, the regulator 30 provides the second control signal 32 so as to regulate the second charging or discharging current 28 at least partially according to the first charging or discharging current 22 flowing to or from the first battery pack 4. By this operation, the charge/discharge system 2 advantageously avoids or mitigates the above-mentioned problems, particularly for pack-to-pack variations in the battery packs 10, 4 and/or differences in the corresponding battery pack capacities.

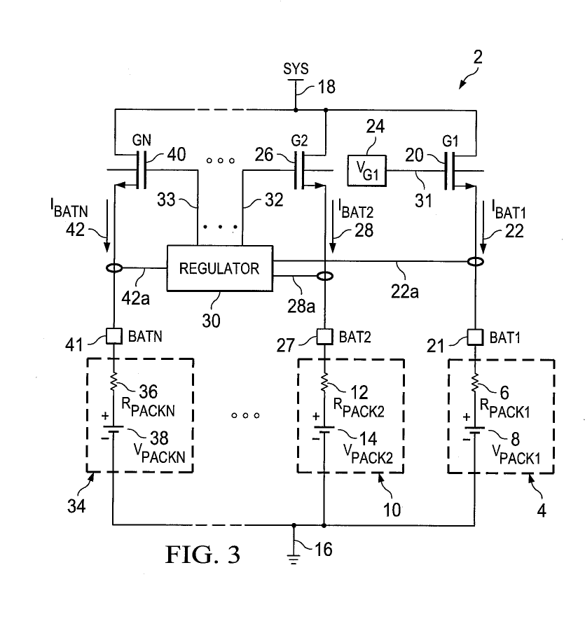

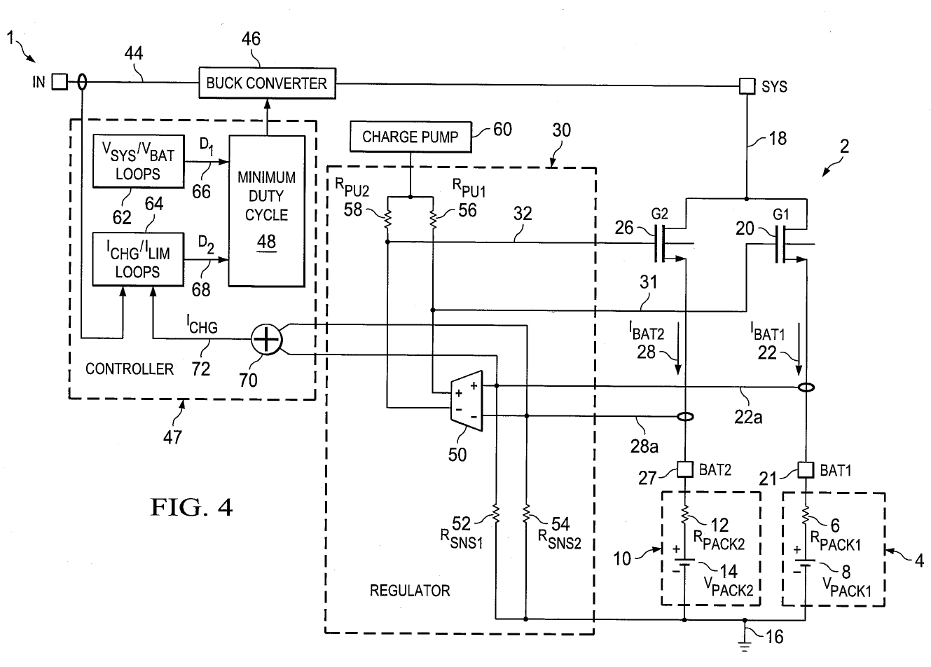

In the example of FIGS. 1 and 2, the first and second transistors are N-channel MOSFET devices, although other forms of charging transistors 20, 26 may be used. The first transistor 20 has a source connected to a battery pack connection terminal 21 (BAT1), a drain connected to the system power terminal 18, and a control terminal G1 (e.g., gate) connected to receive a first control signal 31 from a gate voltage source 24 (V_{GS}). Bipolar or other types of charging/discharging control transistors can be used for the first and second transistors 20, 26, having emitter, collector, and base terminals. In certain embodiments (e.g., FIGS. 3 and 4 below), the first control signal 31 is provided by the regulator circuit 30, such as from an output terminal of an operational transconductance amplifier (OTA) 50 as seen in FIG. 4. In one possible implementation, the first gate control signal 31 is provided so as to set the first charging or discharging current 22 to a desired level, and this first charging current flow can be controlled in open or closed-loop fashion in various embodiments. Moreover, the regulator 30 advantageously controls the second charging/discharging current 28 based in whole or in part on the first charging/discharging current 22. As seen in FIGS. 1 and 2, the second transistor 26 is also an N-channel FET, with a drain connected to the system power node 18, a source connected to a second battery terminal 27 (BAT2), and a gate G2 connected to receive the control signal 32 from the regulator circuit 30. In certain embodiments, the regulator 30 provides the control signal 32 to operate the second transistor 26 in an ohmic mode (triode range) to selectively regulate the second charging or discharging current 28 at least partially according to the first charging or discharging current 22, and the regulator 30 may also control the first transistor 20 for operation in the ohmic mode via control signal 31.

The regulator circuit 30 in certain embodiments receives one or more feedback signals. For example, the regulator 30 receives a first feedback signal 22a representing or otherwise indicative of the first charging or discharging current 22, and the regulator 30 may also receive a second feedback circuit 28a indicative of the second charging or discharging current 28. Any suitable sensor circuitry may be used in the system 2 for providing the feedback signal(s) 22a, 28a, such as a sense FET or sense resistor connected in the corresponding circuit branch between the charging transistor and the battery pack terminal 21, 27, along with connections to one or more associated circuit branch nodes for sensing a voltage representing the current flow through the sensing component (not shown).

In one nonlimiting example, the second control signal 32 is provided by the regulator circuit 30 in order to approximately equalize the first and second charging or discharging currents 22 and 28. For example, the regulator circuit 30 in certain embodiments may include an operational amplifier (op amp), operational transconductance amplifier (OTA), or other circuit which creates the signal 32 based at least partially on the difference between the feedback signals 22a and 28a. In this regard, the closed loop nature of the regulator operation will tend to adjust the drive signal provided to the gate G2 of the second transistor 26 in response to changes between the first charging/discharging current 22 and the second charging/discharging current 28, whereby the first and second battery pack currents 22 and 28 may not be exactly equalized at certain points in time, but the regulator 30 operates to approximately equalize the second charging/discharging current 28 with the first charging/discharging current 22.

In other embodiments, the regulator 30 controls the second charging/discharging current 28 via the control signal 32 at least partially according to a ratio of capacities of the battery packs 4 and 10. For example, if the capacity of the first battery pack 4 is twice that of the second battery pack 10, the regulator 30 provides the second control signal 32 to regulate the second charging/discharging current 28 to be approximately half of the first charging/discharging current 22. Other implementations are contemplated, in which the second current 28 is controlled based on the ratio of battery pack capacities multiplied by a non-unity scaling factor. In addition, the regulator 30 may provide both control signals 31 and 32 in certain embodiments to regulate the ratio of the first and second currents 22, 28 according to the ratio of the first and second battery pack capacities. For example, in the embodiment of FIG. 4 below, the regulator circuit 30 provides the first control signal 31 to the first transistor 20 to regulate the first charging or discharging current 22 at least partially according to the second charging or discharging current 28, where the use of a differential input, differential output OTA 50 facilitates provision of the first and second control signals 31 and 32 according to the difference between the feedback signals 22a and 28a.

In certain embodiments, moreover, the regulator 30 generates the second control signal 32 in order to selectively regulate the second current 28 at least partially according to the first current 22 only when voltages V_{PACK1} and V_{PACK2} are both above a predetermined threshold, such as about 3.3 V, and otherwise may separately or independently charge the battery packs when one or both of the pack voltages are at or below the threshold. Thus, for example, the regulator 30 may provide the control signal 32 independent of the feedback signal(s) 22a, 28a until both the battery pack voltages V_{PACK1} and V_{PACK2} exceed the predetermined threshold, after which the second charging/discharging current 28 is regulated at least partially according to the first charging/discharging current 22.

FIG. 3 illustrates another possible embodiment including an integer number N battery packs, where N is greater than two. In this example, the system 2 also includes a third transistor 40 with a source connected to a third battery pack terminal 41 (BATN), a drain connected to the system power node 18, and a gate terminal GN connected to receive a third control signal 33 from the regulator 30. The third battery pack 34 includes a pack cell or cells 38 with a pack voltage V_{PACKN}, and the figure schematically illustrates a corresponding series pack resistance 36 (R_{PACKN}). The third transistor 40 operates according to a third control signal 33 from the regulator 30 to control flow of a third charging or discharging current 42 (I_{BATN}) between the system power node 18 and the third battery pack 34. In this case, the third transistor 40 is connected in series with the third battery pack 34 in a third charging circuit that is parallel with the first and second charging circuits. In such implementations, moreover, the regulator circuit 30 provides the third control signal 33 to the third transistor 40 in order to regulate the third charging/discharging current 42 at least partially according to the first charging/discharging current 22. The regulator 30 may also employ a third feedback signal 42a indicative of the third charging/discharging current 42 in generating the third control signal 33, and may similarly employ the second feedback signal 28a in generating the second control signal 32 for controlling the second transistor 26. In this manner, the charging and/or discharging currents 28, 42 flowing in the second through N^{th} battery packs 10, 34 are regulated at least in part according to the current 22 flowing in the first (e.g., reference) battery pack 4.

As with the embodiments which use two parallel-connected battery packs (e.g., packs 4 and 10 above), the regulator 30 in FIG. 3 may provide the control signals 32, 33 for embodiments employing three or more parallel-connected battery packs to approximately equalize the second through N^{th} currents 28, 42 with the first battery pack charging/discharging current 22. In other embodiments, the regulator 30 may provide the control signals 32, 33 so as to regulate ratios of the second through N^{th} currents to the first charging/discharging current 22. Moreover, this regulation of the second through N^{th} currents 28, 42 with respect to the charging/discharging current of the reference pack 4 may be performed selectively when the corresponding battery pack voltages 8, 14 and 38 (e.g., V_{PACK1}, V_{PACK2} and a V_{PACKN}) exceed the predetermined threshold (e.g., 3.3 V in one example), and otherwise the packs may be independently (separately) charged, for example, by the regulator 30 providing the control signals 32 and 33 independent of the feedback signal 22a.

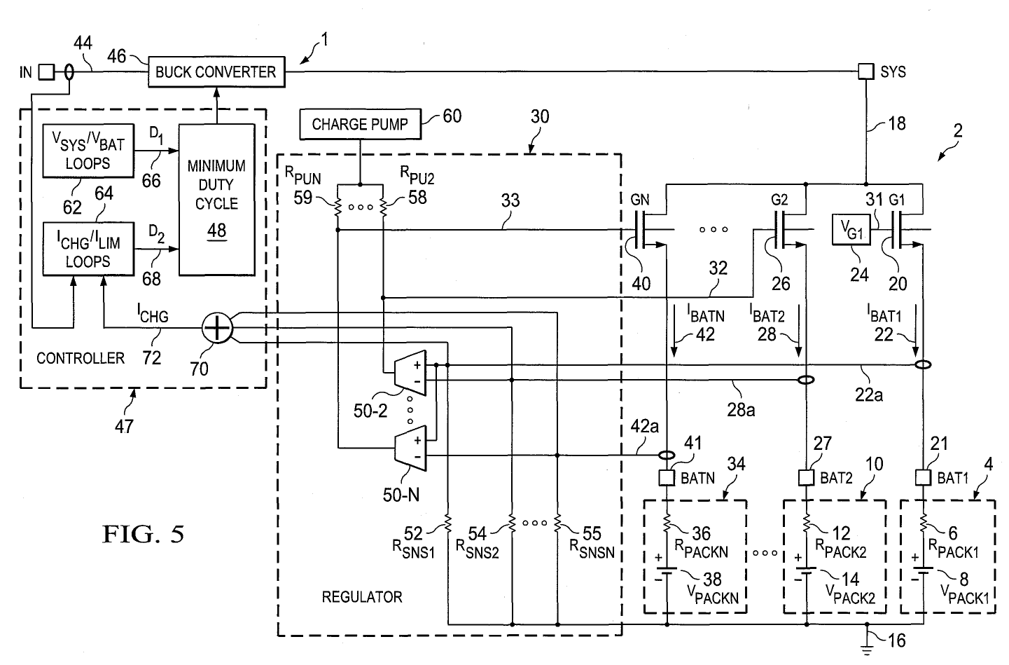

Referring also to FIGS. 4 and 5, FIG. 4 illustrates an exemplary charge/discharge system 2 with a regulator circuit 30 including an operational transconductance amplifier (OTA) 50 for charging two parallel-connected battery packs 4 and 10, and FIG. 5 depicts a regulator circuit 30 using N−1 operational transconductance amplifiers 50-2 and 50-N to charge three or more parallel-connected battery packs 4, 10 and 34. As seen in these figures, moreover, the controller 47 operates the buck converter 46 using a minimum duty cycle circuit or module 48 setting a duty cycle of the buck converter 46 (e.g., duty cycle of the buck converter switch S in FIGS. 1 and 2 above) as a smaller of first and second duty cycle signals or values 66 (D₁) and 68 (D₂) received from voltage and current control loop components 62 and 64, respectively. In this example, the voltage control loops 62 set the duty cycle signal or value 66 based on the system voltage (e.g., the voltage between the system power node 18 and the system ground node 16) and the battery voltages (V_{PACK1}, V_{PACK2} and a V_{PACKN}). The current control loops 64 provide the second duty cycle signal or value 68 based on the charging current (e.g., I_{CHG} in FIG. 1 above) and any current limit value I_{LIM} associated with safe or desired operation of the DC power source 5 (FIG. 1). In this regard, the current control loops 64 employ a feedback signal indicating the input current at the input node 44, as well as a total charging current feedback signal or value 72 (I_{CHG}) obtained by a summing junction circuit 70 which represents the sum of the charging/discharging currents 22 and 28, where the summing junction circuitry 70 receives the feedback signals 22a and 28a as inputs in certain embodiments.

As seen in FIG. 4, the regulator circuit 30 includes a differential input, differential output OTA 50 with a first or positive differential input terminal (+) connected to the first feedback signal 22a, along with a second differential input terminal (−) connected to receive the second feedback signal 28a. The outputs of the OTA 50 provide adjustable current sinking, and are connected through pull-up resistors 56 and 58 (R_{PU1} and R_{PU2}) to a charge pump 60. In addition, the positive (+) differential output of the OTA 50 is connected in the illustrated embodiment to provide the first control signal 31 to the control terminal G1 of the first transistor 20 to control flow of the first charging or discharging current 22 at least partially according to the first and second feedback signals 22a and 28a (e.g., according to the difference therebetween), and the second output terminal (−) provides the second control signal 32 to the control terminal G2 of the second transistor 26 to control flow of the second charging or discharging current 28 at least partially according to the first and second feedback signals 22a and 28a. Other embodiments are possible in which a single-ended output is provided from the OTA 50, which is used to provide the second control signal 32 to regulate the second charging/discharging current 28 at least partially according to the first charging/discharging current 22. In these implementations, the output of the OTA selectively sinks current from the charge pump through pull-up resistor 58 to control the signal 32 provided to the gate G2 of the second transistor 26. In implementations in which the OTA 50 provides a differential output (e.g. as shown in FIG. 4), the second output (+) sinks current from the charge pump 60 through the first pull-up resistor 56 in order to adjust the control signal 31 provided to the gate G1 of the first transistor 20.

Moreover, as discussed above, the signal(s) 32, 31 may be provided in certain embodiments in order to operate the associated transistor(s) 26, 20 in a triode or ohmic mode, whereby the control signal(s) effectively set the source-drain impedance (R_{DSON}) of the controlled charging/discharging transistor 26 in a substantially linear fashion for regulating the second charging current 28 at least partially according to the feedback signal 22a representing the first charging/discharging current 22. Also, as discussed above, the cross-regulation may be performed selectively by the regulator circuit 30, with the battery packs 4, 10 being separately or independently charged until both pack voltages 8, 14 exceed a predetermined threshold, after which the regulator 30 controls the charging/discharging current 28 at least partially according to the charging/discharging current 22. As seen in FIG. 4, moreover, sense resistors 52 and 54 (R_{SNS1} and R_{RSNS2}) are connected between the feedback signal lines 22a and 28a, respectively, where these resistors may be of generally equal value for equalizing the charging/discharging currents 22 and 28 where the battery packs 4 and 10 are of substantially similar capacities. In other embodiments, for example, where the first battery pack 4 has a capacity of approximately twice that of the second battery pack 10, the sense resistances 52 and 54 may have corresponding value ratios, such as the resistor 54 having a resistance value approximately twice that of the sense resistor 52. By this ratiometric adjustment of the sense resistors 52, 54, the OTA 50 operation can be set such that the regulator 30 provides the control signal 32 to regulate the ratio of the first and second charging/discharging currents 22 and 28 at least partially according to the ratio of the corresponding battery pack capacities.

FIG. 5 illustrates another implementation, in which three or more battery packs are used (e.g., packs 4, 10 and 34), including a third exemplary battery pack 34, with a corresponding third sense resistor 55 (R_{SNSN}) and pull-up resistor 59 (R_{PUN}). In this example, moreover, N−1 OTAs are used including OTA 50-2 for regulating the second charging/discharging current 28 based at least partially on the first charging/discharging current 22, as well as OTA 50-N for regulating the third charging/discharging current 42 according to the first charging/discharging current 22. In this case, the OTAs 50 provide single-ended outputs to generate the signals 32 and 33 for controlling the second and third transistors 26 and 40, respectively. In addition, the first differential input terminal (+) of each OTA 50 is connected to receive the first feedback signal 22a representing the first charging/discharging current 22. The other differential input (−) of the OTA 50-2 is connected to receive the second feedback signal 28a, and the (−) terminal of the other OTA 50-N is connected to receive a third feedback signal 42a representing the charging/discharging current 42 associated with the third battery pack 34. The first OTA 50-2 provides the output signal 32 to the transistor 26 so as to control flow of the second charging/discharging current 28 at least partially according to the first and second feedback signals 22a, 28a. In addition, the second OTA 50-N provides the control signal 33 to the third transistor 40 to control the third charging/discharging current 42 at least partially according to the first and second feedback signals 22a, 28a. In this embodiment, therefore, multiple OTAs can be used for individually regulating the charging/discharging current of the second through N^{th} battery packs 10, 34 with respect to a reference charging current 22 associated with the first battery pack 4.

The present disclosure further provides methods for charging or discharging multiple parallel-connected battery packs (e.g., battery packs 4, 10, 34 above) in a portable electronic device 1. The methods involve controlling flow of a first charging or discharging current (e.g., current 22 above) to or from a first battery pack 4 in a first charging circuit coupled between a system power node (e.g., SYS node 18 above) and a system ground (e.g., node 16), as well as regulating flow of a second charging or discharging current (e.g., current 28) to or from a second battery pack (e.g., battery pack 10) in a second charging circuit connected in parallel with the first charging circuit at least partially according to the first charging or discharging current. In certain embodiments, regulation of the second charging or discharging current includes substantially equalizing the first and second charging or discharging currents 22, 28. Other embodiments involve regulating a ratio of the first and second charging or discharging currents 22, 28 at least partially according to a ratio of capacities of the first and second battery packs 4, 10, for example, as described above. In addition, embodiments of the charging/discharging methods of the present disclosure may involve independently charging the battery packs when one or more of the pack voltages are at or below a predetermined threshold, and regulating the second charging/discharging current at least partially according to the first charging or discharging current 22 when the battery pack voltages exceed the threshold.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been disclosed with respect to only one of multiple implementations, such feature may be combined with one or more other features of other embodiments as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

What is claimed is:

1. A battery pack charge/discharge system for charging or discharging multiple parallel-connected battery packs, the system comprising:
a first transistor operable according to a first control signal to control flow of a first charging or discharging current between a system power node and a first battery pack, the first transistor connected in series with the first battery pack in a first charging circuit;
a second transistor operable according to a second control signal to control flow of a second charging or discharging current between the system power node and a second battery pack, the second transistor connected in series with the second battery pack in a second charging circuit, the first and second charging circuits being connected in parallel between the system power node and a system ground node; and
a regulator circuit providing the second control signal to the second transistor to regulate the second charging or discharging current at least partially according to the first charging or discharging current.

2. The system of claim 1, wherein the regulator circuit provides the second control signal to approximately equalize the first and second charging or discharging currents.

3. The system of claim 1, wherein the regulator circuit provides the second control signal to regulate a ratio of the first and second charging or discharging currents at least partially according to a ratio of capacities of the first and second battery packs.

4. The system of claim 1, wherein the regulator circuit provides the second control signal to selectively regulate the second charging or discharging current at least partially according to the first charging or discharging current only when voltages of the first and second battery packs both exceed a predetermined threshold.

5. The system of claim 4, wherein the second transistor is a field effect transistor, and wherein the regulator circuit provides the second control signal to operate the second transistor in an ohmic mode to selectively regulate the second charging or discharging current at least partially according to the first charging or discharging current.

6. The system of claim 1, wherein the second transistor is a field effect transistor, and wherein the regulator circuit provides the second control signal to operate the second transistor in an ohmic mode to selectively regulate the second charging or discharging current at least partially according to the first charging or discharging current.

7. The system of claim 1, wherein the regulator circuit provides the first control signal to the first transistor to regulate the first charging or discharging current at least partially according to the second charging or discharging current.

8. The system of claim 7, wherein the regulator circuit includes an operational transconductance amplifier, comprising:
a differential input, including:
a first input terminal connected to a first feedback signal indicative of the first charging or discharging current, and
a second input terminal connected to a second feedback signal indicative of the second charging or discharging current; and
a differential output, including:
a first output terminal providing the first control signal to a control terminal of the first transistor to control flow of the first charging or discharging current at least partially according to the first and second feedback signals, and
a second output terminal providing the second control signal to a control terminal of the second transistor to control flow of the second charging or discharging current at least partially according to the first and second feedback signals.

9. The system of claim 1, wherein the regulator circuit includes an operational transconductance amplifier, comprising:
a differential input, including:
a first input terminal connected to a first feedback signal indicative of the first charging or discharging current, and
a second input terminal connected to a second feedback signal indicative of the second charging or discharging current; and
an output providing the second control signal to a control terminal of the second transistor to control flow of the second charging or discharging current at least partially according to the first and second feedback signals.

10. The system of claim 9, comprising:
a third transistor operable according to a third control signal to control flow of a third charging or discharging current between the system power node and a third battery pack, the third transistor connected in series with the third battery pack in a third charging circuit, the first, second and third charging circuits being connected in parallel between the system power node and the system ground node;
wherein the regulator circuit comprises a second operational transconductance amplifier, comprising:
a differential input, including:
a first input terminal connected to the first feedback signal indicative of the first charging or discharging current, and
a second input terminal connected to a third feedback signal indicative of the third charging or discharging current; and
an output providing the third control signal to a control terminal of the third transistor to control flow of the third charging or discharging current at least partially according to the first and second feedback signals.

11. The system of claim 1, comprising:
a third transistor operable according to a third control signal to control flow of a third charging or discharging current between the system power node and a third battery pack, the third transistor connected in series with the third battery pack in a third charging circuit, the first, second and third charging circuits being connected in parallel between the system power node and the system ground node;
wherein the regulator circuit provides the third control signal to the third transistor to regulate the third charging or discharging current at least partially according to the first charging or discharging current.

12. A portable electronic device, comprising:
first and second battery packs coupled in parallel between a system power node and a system ground node, and operative to selectively provide electrical power to a system load;
a power input operative to receive input electrical power from a connected power source;
a converter circuit operatively coupled with the power input to selectively convert the input electrical power from the power source to provide power to the system power node for powering the system load and/or charging the plurality of battery packs; and
a battery pack charge/discharge system for charging or discharging the plurality of battery packs, the battery pack charge/discharge system comprising:
a first transistor operable according to a first control signal to control flow of a first charging or discharging current between the system power node and the first battery pack, the first transistor connected in series with the first battery pack to form a first charging circuit between the system power node and the system ground node,
a second transistor operable according to a second control signal to control flow of a second charging or discharging current between the system power node and the second battery pack, the second transistor connected in series with the second battery pack to form a second charging circuit in parallel with the first charging circuit between the system power node and the system ground node, and
a regulator circuit providing the second control signal to the second transistor to regulate the second charging or discharging current at least partially according to the first charging or discharging current.

13. The portable electronic device of claim 12, wherein the regulator circuit provides the second control signal to approximately equalize the first and second charging or discharging currents.

14. The portable electronic device of claim 12, wherein the regulator circuit provides the second control signal to regulate a ratio of the first and second charging or discharging currents at least partially according to a ratio of capacities of the first and second battery packs.

15. The portable electronic device of claim 12, wherein the regulator circuit provides the second control signal to selectively regulate the second charging or discharging current at least partially according to the first charging or discharging current only when voltages of the first and second battery packs both exceed a predetermined threshold.

16. The portable electronic device of claim 12, wherein the regulator circuit provides the first control signal to the first transistor to regulate the first charging or discharging current at least partially according to the second charging or discharging current.

17. A method for charging or discharging multiple parallel-connected battery packs in a portable electronic device, the method comprising:
controlling flow of a first charging or discharging current to or from a first battery pack in a first charging circuit coupled between a system power node and a system ground node of the portable electronic device; and
regulating flow of a second charging or discharging current to or from a second battery pack in a second charging circuit connected in parallel with the first charging circuit at least partially according to the first charging or discharging current.

18. The method of claim 17, wherein regulating flow of the second charging or discharging current comprises substantially equalizing the first and second charging or discharging currents.

19. The method of claim 17, wherein regulating flow of the second charging or discharging current comprises regulating a ratio of the first and second charging or discharging currents at least partially according to a ratio of capacities of the first and second battery packs.

20. The method of claim 17, comprising:
independently charging the first and second battery packs when voltages of one or both of the first and second battery packs is or are at or below a predetermined threshold; and
regulating the second charging or discharging current at least partially according to the first charging or discharging current when the voltages of the first and second battery packs both exceed the predetermined threshold.
